(19) United States
(12) Patent Application Publication
(10) Pub. No.: US 2020/0224477 A1
(43) Pub. Date: Jul. 16, 2020

(54) FLAP FITTING AND ITEM OF FURNITURE

(71) Applicant: HETTICH-ONI GMBH & CO. KG, Vlotho (DE)

(72) Inventors: Uwe SOBOLEWSKI, Bünde (DE); Stefan ANDSCHUS, Lübbecke (DE); Michael TASCHE, Bielefeld (DE); Oliver SCHAEL, Kirchlengern (DE)

(21) Appl. No.: 16/628,139

(22) PCT Filed: Jun. 26, 2018
(86) PCT No.: PCT/EP2018/067154

§ 371 Date: Jan. 2, 2020

(30) Foreign Application Priority Data
Jul. 3, 2017 (DE) 10 2017 114 775.6

(51) Int. Cl. E05F 5/00; E05F 1/10

(52) U.S. Cl. CPC E05F 5/006; E05F 5/10; E05F 1/1058

(57) ABSTRACT

A flap fitting for an item of furniture includes a housing which can be fixed to a body. A supporting arm is rotatably mounted on the housing. The flap fitting includes a pivotably mounted control arm. The supporting arm and the control arm can be hingedly connected to a flap at an attachment point via spaced-apart axes of rotation. A damper is provided at the attachment point and can be actuated via a movement of the supporting arm and/or the control arm in the event of an opening movement of the flap, before the maximum opening position is reached.

### BACKGROUND AND SUMMARY OF THE INVENTION

Exemplary embodiments of the present invention relate to a flap fitting, in particular for an item of furniture, having a housing, which is fixable on a body, and on which a supporting lever is rotatably mounted, and a pivotably mounted control lever, wherein the supporting lever and the control lever can be articulated with a flap on an attachment via spaced-apart axes of rotation, and an item of furniture having a flap held on a body.

WO 2009/060723 discloses a flap fitting, in which a flap fitting is pivotable from a closed position on an opening of a furniture body into an open position, wherein the flap is pivoted forward from a vertical position with an upper edge to release the opening on the furniture body. This type of pivot movement is advantageous because the user can stand in the lower region of the flap and does not have to evade the flap during an opening movement, as is the case with doors having rotational movements around a vertical axis. A damper can be provided on the housing of the flap fitting in this case to damp a closing or opening movement of the flap. It is disadvantageous in this case that the housing on the furniture body requires a comparatively large amount of installation space.

Accordingly, exemplary embodiments of the present invention are directed to a flap fitting that ensures comfortable handling and is compactly constructed.

In the flap fitting according to the invention, an attachment is provided, on which a supporting lever and a control lever are articulated via axes of rotation, wherein a damper is provided on the attachment which is actuatable via a movement of the supporting lever and/or the control lever during an opening movement of the flap before reaching the maximally open position. The installation space on the attachment can thus be used to provide an opening damping that improves the handling by avoiding loud impact noises during an opening movement. Shortly before reaching the maximally open position, for example, in a range between 4 to 8 cm before the opening position, the damper can decelerate the opening movement to reduce the mechanical strain of the fitting parts and avoid impact noises. In this case, the part of the flap fitting fixed on the body can be formed compactly, since the opening damping is performed at least partially via the damper on the attachment.

In one design of the invention, the damper is formed as a linear damper and comprises a damper housing and a piston rod retractable into or extendable out of the damper housing. The damper can operate, for example, as a fluid damper having a hydraulic oil as a damping fluid, so that high damping forces can be provided. To ensure that the damper is ready for the next damping procedure again after a closing procedure, the damper can be pre-tensioned via a spring in an extended position in this case.

To avoid lateral forces on the damper, a guide can be provided on the attachment, along which the damper is retractable or extendable. The guide can be formed, for example, by an oblong hole on the attachment in which a pin is guided.

The attachment can comprise, for example, a U-shaped steel plate, in which the damper is accommodated and on which the axes of rotation are formed for the articulated mounting of the supporting lever and the control lever. Alternatively, the attachment can also be embodied in multiple parts.

An actuating surface or contact surface is preferably arranged on the supporting and/or control lever, which presses against an actuating surface or contact surface of the damper unit from a predetermined angle position of the flap fitting. The damper unit can comprise, for example, two actuating surfaces, which are actuated during a closing movement by means of a first actuating surface and are actuated during the opening movement by means of a second actuating surface, so that an opening damping and a closing damping take place via a single damper unit.

In the flap fitting according to the invention, the supporting lever can be coupled to the control lever via a gearing. For this purpose, the supporting lever can drive a first gear wheel during a rotational movement, which directly or indirectly drives a second gear wheel, wherein the control lever is rotatably mounted on the second gear wheel spaced apart from the axis of rotation of the second gear wheel. The pivot movement of the flap during the opening and closing can be optimized by the movable mounting of the axis of rotation of the control lever. In particular, a horizontal movement of the flap at the beginning of the opening movement can be kept small, so that the flap is pivoted essentially vertically upward after a starting movement, wherein an upper region can pivot forward away from the flap fitting. Precise guiding can be ensured by the coupling of the supporting lever and the control lever via gear wheels.

A force accumulator is preferably provided, which pre-tensions the flap in a closing range in the closing direction and pre-tensions the flap in an opening range in the opening direction after overcoming the dead center. The operating comfort is thus enhanced, since the user only has to introduce forces at the beginning of the opening or closing movement and the flap can then open or close automatically after overcoming the dead center. Both the opening and also the closing movement can be damped at least in an end region.

### BRIEF DESCRIPTION OF THE DRAWING FIGURES

The invention is explained in greater detail hereafter on the basis of an exemplary embodiment with reference to the appending drawings. In the figures:

FIG. 1 shows a perspective view of an item of furniture according to the invention having a flap fitting;

FIG. 2 shows a perspective view of the front panel having a flap fitting;

FIGS. 3A and 3B show two views of the item of furniture of FIG. 1 having an open flap;

FIGS. 4A and 4B show two views of the pivot fitting in a closed position;

FIG. 5 shows a view of the pivot fitting having partially removed housing in a closed position;

FIGS. 6 to 8 show multiple views of the flap fitting of the figure in different positions;

FIG. 9 shows a view of the flap fitting in an open position;

FIGS. 10A and 10B show two detail views of the attachment of the flap fitting in a closed position;

FIGS. 11A to 11C show multiple views of the flap fitting and the attachment in an open position, and

FIG. 12 shows a view of a modified flap fitting which is arranged in a side wall of an item of furniture.

### DETAILED DESCRIPTION

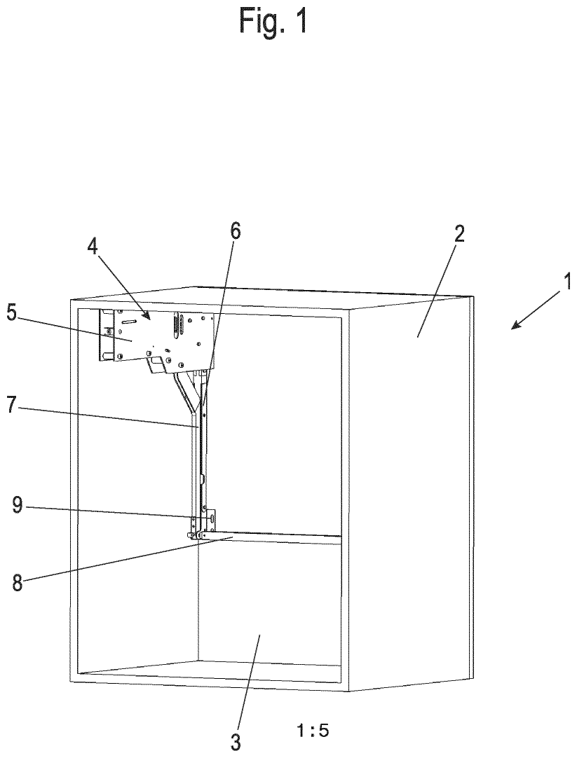

An item of furniture 1 comprises a furniture body 2, for example, for a hanging cabinet in a kitchen, in which the rear wall was omitted in FIG. 1. The furniture body 2 is closed by a flap 3 mounted in a pivotable manner on a front side. A flap fitting 4, which comprises a housing 5, is installed in each case on opposing side walls of the furniture body 2 for guiding the flap 3. Each flap fitting 4 comprises a supporting lever 6 and a control lever 7, which are connected via an attachment 9 to the flap 3. The two attachments 9 of the opposing flap fittings 4 are synchronized via a rod 8, so that the flap fittings 4 are moved essentially synchronously during the opening and closing of the flap 3.

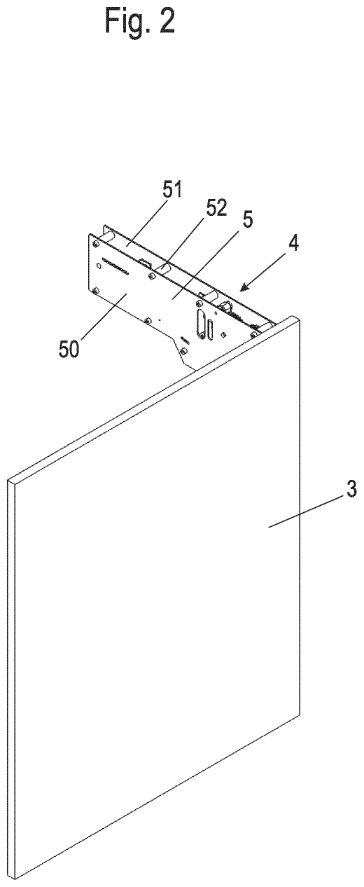

A flap fitting 4 having the flap 3 without furniture body 2 is shown in FIG. 2. The housing 5 of the flap fitting 4 comprises two side walls 50 and 51, which are arranged spaced apart from one another via a plurality of spacers 52. Other housing forms can also be used for the housing 5.

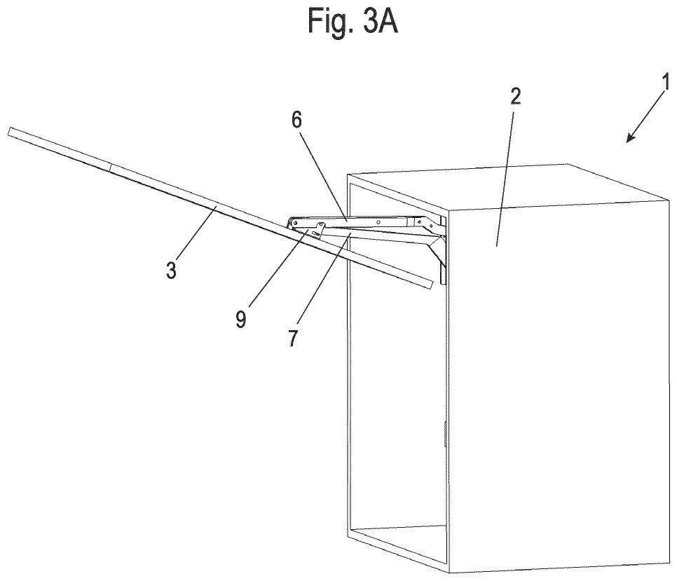

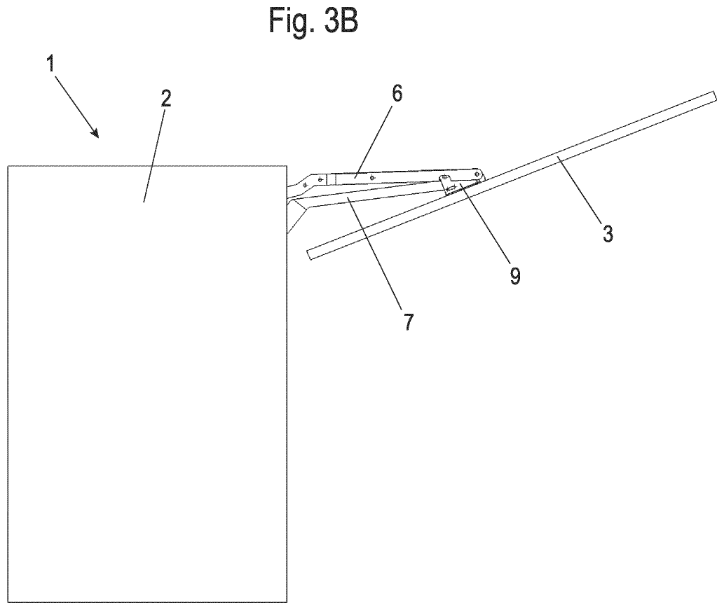

The flap 3 is shown in an open position in FIGS. 3A and 3B. The flap 3 has been pivoted with an upper region forward and away from the furniture body 2, while a lower region of the flap 3, on which a handle element (not shown) is installed, was pivoted essentially vertically upward. The user thus only has to execute a slight horizontal movement and essentially a vertical movement during the opening and closing of the flap 3.

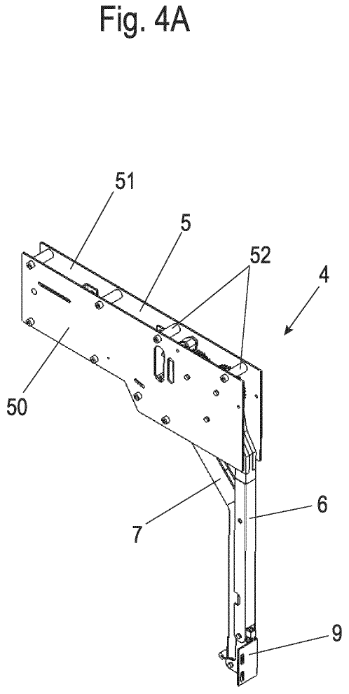

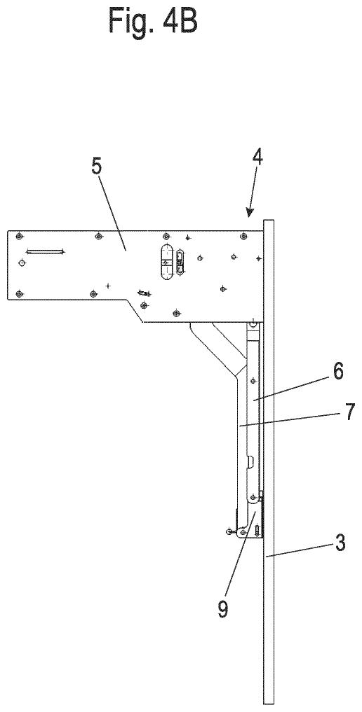

The flap fitting 4 is shown in a closed position in FIGS. 4A and 4B. The supporting lever 6 and the control lever 7 are arranged partially in parallel to one another and extend essentially in the vertical direction up to the attachment 9, which is installed on the flap 3.

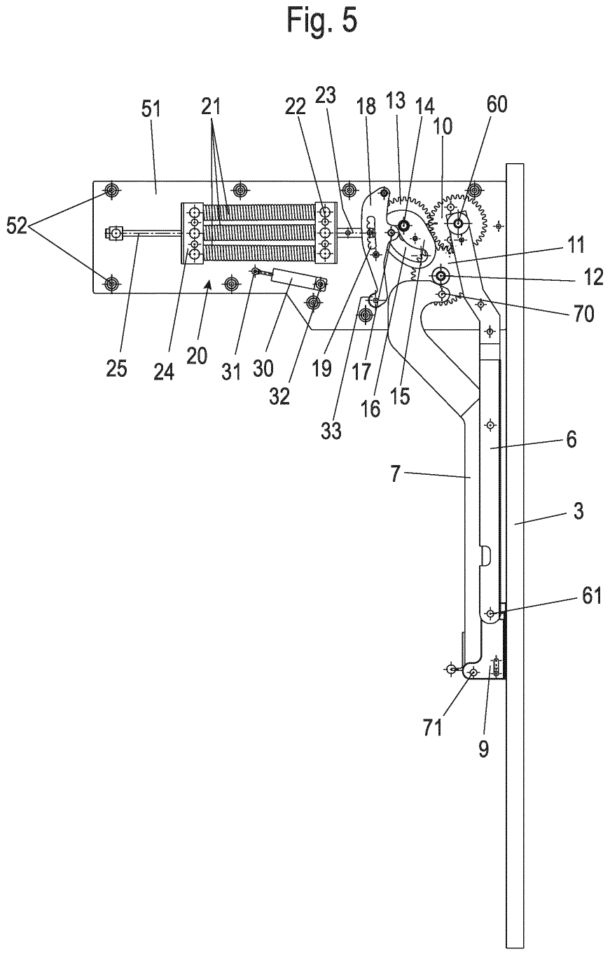

In FIG. 5, the flap fitting 4 is shown in a closed position without the side wall 50 of the housing. The supporting lever 6 is articulated at one end around an axis of rotation 61 on the attachment 9 and on the opposing side around an axis of rotation 60, which is provided on the housing 5. A first gear wheel 10, which is engaged with a second gear wheel 11, which is rotatably mounted around an axis of rotation 12 on the housing 5, is connected for conjoint rotation around the axis of rotation 60 to the supporting lever 6.

An axis of rotation 70, on which the control lever 7 is rotatably mounted, is provided on the second gear wheel 11 spaced apart from the axis of rotation 12 of the gear wheel 11. The control lever 7 is rotatably mounted around an axis of rotation 71 on the attachment 9 at the opposing end. The axis of rotation 70 thus moves during an opening and closing procedure of the flap 3, which is held on the attachment 9.

To partially compensate for the weight forces of the flap 3 during the opening and closing, a force accumulator 20 is provided, which comprises three springs 21, in particular traction springs in the illustrated exemplary embodiment, which are arranged between a first spring holder 22 and a second spring holder 24. The second spring holder 24 is fixed in this case via a fastening 25 on the housing 5. The spring holder 22 is connected via a rod 23 to a movable holder 18. A receptacle 19 is provided on the holder 18, on which the rod 23 of the force accumulator 20 is fixed, so that the holder 18 is pre-tensioned by the force accumulator 20. The holder 18 comprises a guide element 17, which is mounted in a curve guide 16 of a control disk 15. The control disk 15 is rotatably mounted here around an axis of rotation 14, which is provided on the housing 5. Furthermore, the control disk 15 is coupled for conjoint rotation to a third gear wheel 13, which is engaged with the first gear wheel 10.

The term “gear wheel” is understood to mean rotating disks having external gear teeth, wherein the external gear teeth extend alternately over the entire circumference or only a part of the circumference. Alternatively, toothed segments, internal gear teeth, or other components can be used as gear wheels, on which teeth are provided for the formfitting engagement with an adjacent gear wheel.

Furthermore, a damper 30 is provided on the housing 5, which is designed as a linear damper, in particular as a fluid, liquid, or air damper, which is held on a fastening element 31 on the housing 5 and comprises a piston-cylinder unit, which generates damping forces upon compression. On the side facing away from the fastening element 31, a contact surface 32 is provided, for example, a contact roller, which can be contacted by an actuating element 33 on the holder 18.

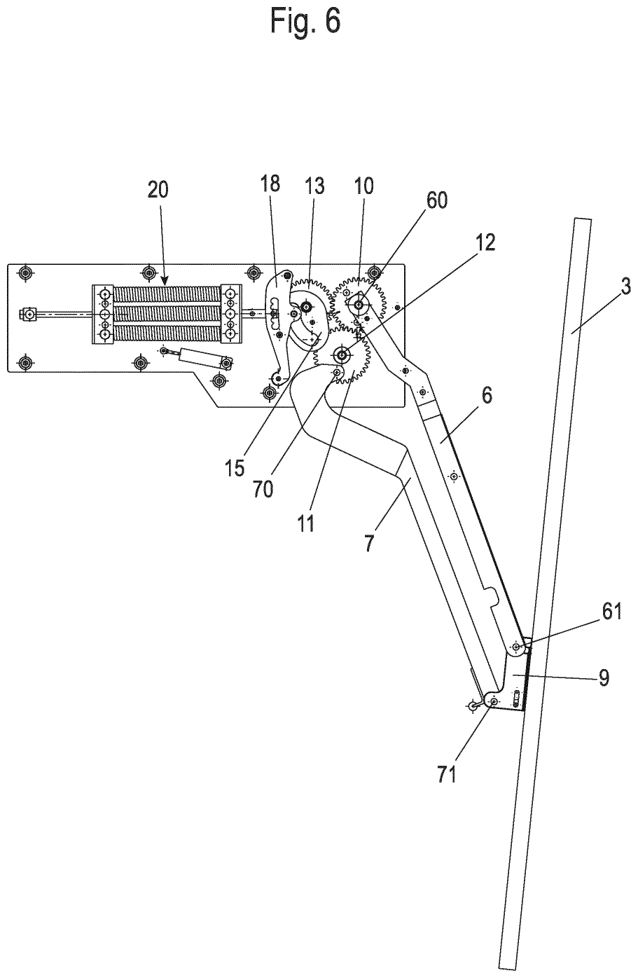

For an opening procedure, a handle arranged in the lower region of the flap 3 is actuated by a user to move the flap 3 forward and upward. The flap 3 is illustrated in a slightly open position in FIG. 6. The force accumulator 20 is further tensioned at the beginning of the opening movement, since the flap 3 is pre-tensioned in the closing direction in the range of the closed position. After overcoming a dead center, the force accumulator 20 assists the movement of the flap 3 in the opening direction.

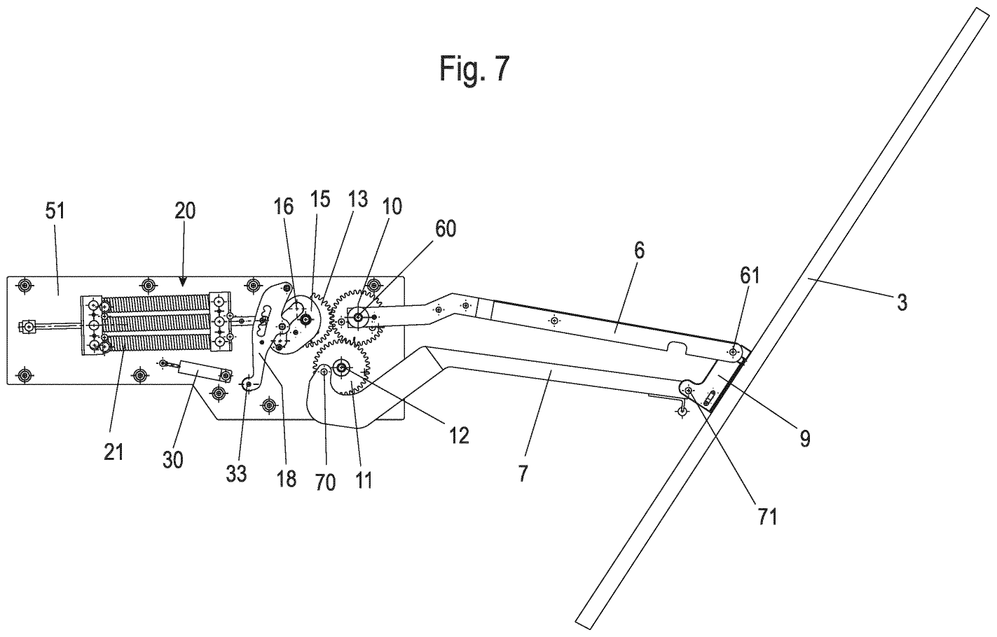

If the flap 3 is moved further in the opening direction, as shown in FIG. 7, both the supporting lever 6 pivots around the axis of rotation 60 and also the control lever 7 pivots around the axis of rotation 70, which is arranged on the rotatable gear wheel 11. From the closed position (FIG. 5) to the position in FIG. 7, the gear wheel 11 was rotated by approximately 90°, so that the axis of rotation 70 has also been displaced. The gear wheels 10 and 11 are engaged in this case, so that the two supporting levers 6 and the control lever 7 are coupled to one another both in the region of the housing 5 and also on the attachment 9. The third gear wheel 13, which rotates the control disk 15, is also driven by the rotation of the gear wheel 10. By rotating the control disk 15, the curve guide 16 is moved, which enables a contraction of the springs 21 of the force accumulator 20 during an opening movement after overcoming the dead center, so that the force accumulator 20 assists the opening procedure.

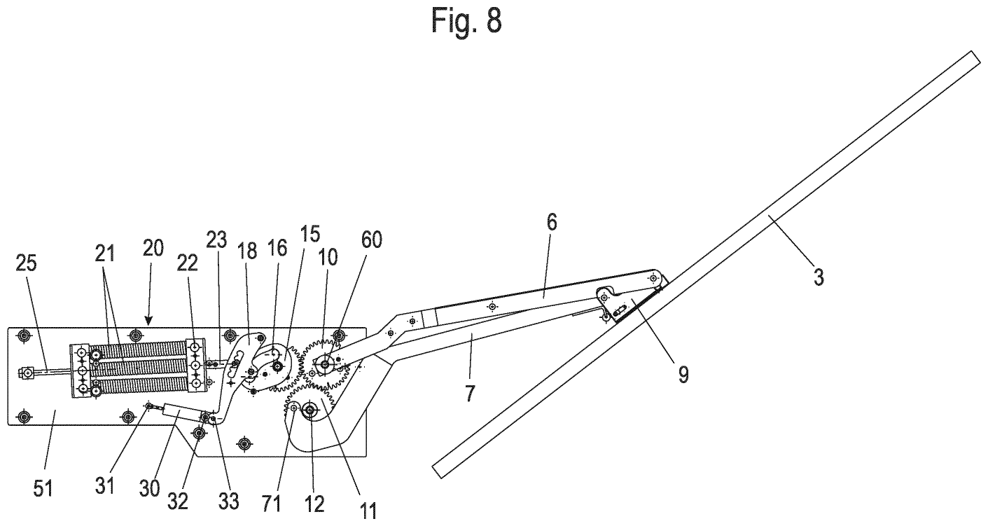

The flap 3 is moved further in the opening direction according to FIG. 8, wherein an upper end of the flap 3 protrudes forward and upward. A lower region of the flap moves essentially vertically upward shortly before the opening on the furniture body 2.

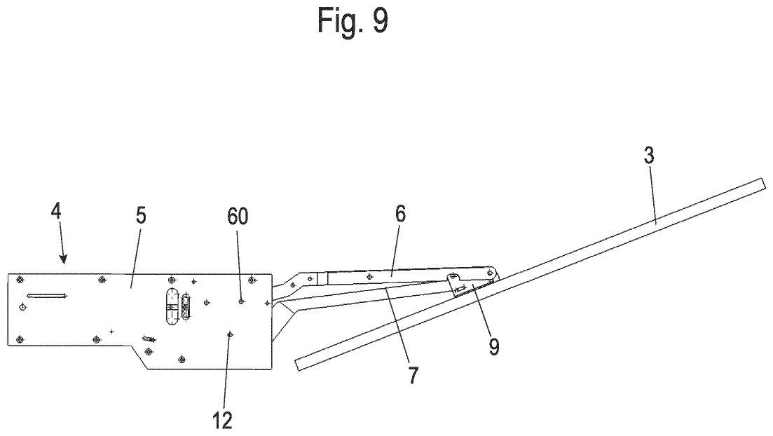

The maximally open position of the flap fitting 4 is shown in FIG. 9. The flap 3 is inclined slightly in relation to the horizontal, for example, in a range between 10° and 20°, and largely exposes the opening region on the furniture body 2. Before reaching the maximally open position, the opening movement can be decelerated, for example, by a damper, which is arranged in the attachment 9. Alternatively, or additionally, the damper 30 is provided in the housing 5, which is compressed by the actuating element 33 on the holder 18, as shown in FIG. 8.

For a closing movement, the user pulls the flap 3 downward against the force of the force accumulator 20 until the flap 3 is again arranged in the closed position illustrated in FIG. 5.

In the illustrated exemplary embodiment, three gear wheels 10, 11, and 13 are arranged in the housing 5. It is also possible to provide a gearing having a predetermined transmission ratio in the housing 5 in order to adapt the tensioning and release of the force accumulator 20 still more strongly to the weight of the flap 3 and other parameters.

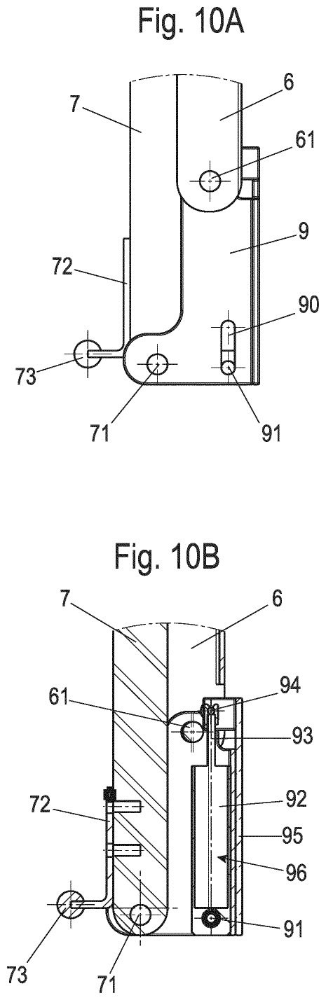

The region of the attachment 9 is shown in a closed position of the flap 3 (FIG. 5) in FIGS. 10A and 10B. The attachment 9 is formed from a U-shaped bent steel plate and comprises a guide 90 in the form of an oblong hole, in which a pin 91 is guided, on opposing side walls. As is recognizable from the sectional view, a damper 96, which comprises a cylindrical damper housing 92 and a piston rod 93 displaceably held on the damper housing 92, is located inside the attachment 9. The piston rod 93 is coupled via a holder 94 to the attachment 9. Furthermore, the axis of rotation 61 for the supporting lever 6 and the axis of rotation 71 for the control lever 7 are provided on the attachment 9.

An actuating element 72, which is formed as an angle and comprises an actuating projection, on which an actuating roller 73 or an actuating element is provided, is located on the control lever 7 adjacent to the axis of rotation 71.

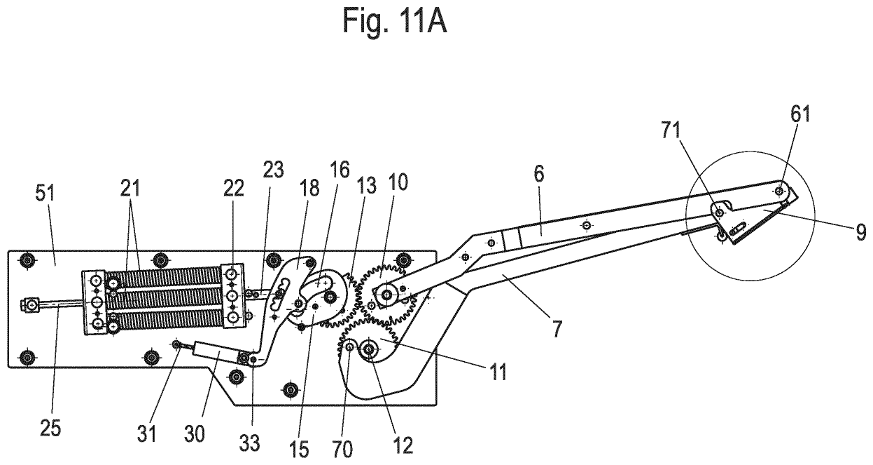

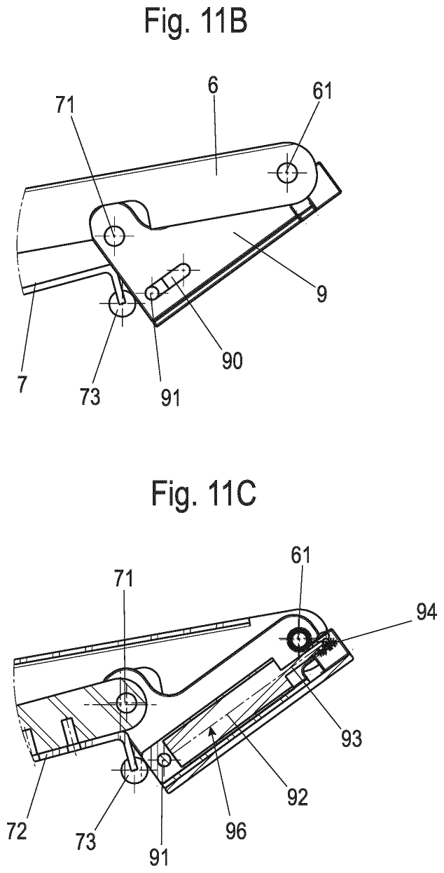

If the flap 3 is now moved from the closed position into the open position, the flap fitting reaches the position shown in FIGS. 11A to 11C shortly before reaching the maximally open position. During the opening of the flap 3, the attachment 9 is pivoted by moving the supporting lever 6 and the control lever 7, and the actuating element 72 encounters the frontal region of the attachment 9 with the actuating roller 73. In this case, the actuating roller 73 can come into contact on the pin 91, which is displaceably mounted in the guide 90. During a further pivot of the flap 3 in the opening direction, the actuating roller 73 of the actuating element 72 presses on the pin 91 and thus on the damper 96, which is compressed, so that the piston rod 93 retracts into the damper housing 92. The damper 96 thus generates damping forces that decelerate the opening movement of the flap 3. The damper can be formed as a hydraulic damper having a damping fluid, for example, an oil, or as an air damper. The damper 96 can be pre-tensioned via a spring (not shown) in an extended position, so that during a closing movement, the damper 96 is moved via the spring back into the extended position and is available for the next damping procedure.

For the opening damping, the damper 96 is used in addition to the damper 30 in the illustrated exemplary embodiment. It is also possible to use only the damper 96 and to dispense with the damper 30 on the housing 5. The damper 96 can be aligned having its longitudinal axis parallel to a plane formed by the flap 3. The position of the damper 96 can furthermore be adjustable via a mechanism to set the action range of the damper 96.

The flap fitting described here is to be understood as solely an example. The articulated arrangement between the supporting and/or control lever on the attachment to actuate the damper directly or indirectly is essential. The flap fitting shown is formed as a four-bar linkage, wherein the supporting and control levers are directly connected to the main body of the flap fitting. Other articulated arrangements are also conceivable, for example, a seven-bar linkage. In this case, the supporting and/or control levers are arranged in the attachment and are connected indirectly to the main body.

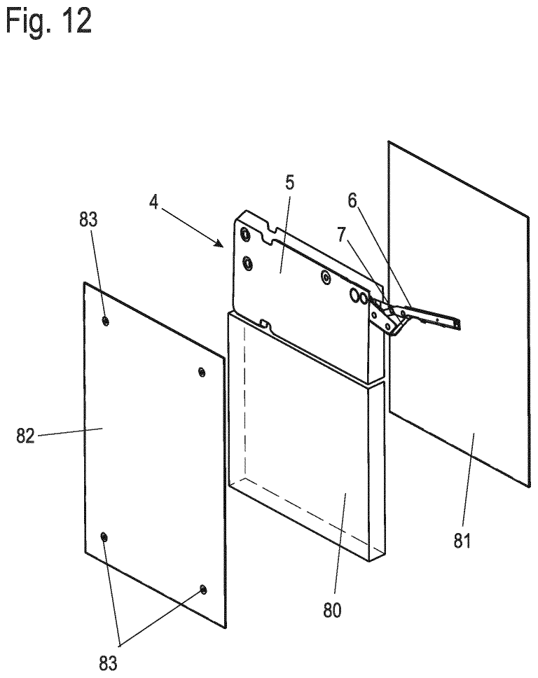

A flap fitting 4 is fastened on an inner side of a side wall of a furniture body 2 in each of FIGS. 1 to 9. In FIG. 12, the flap fitting 4 is not integrated on an inner side but rather in a side wall of the furniture body 2. For this purpose, the side wall comprises a plate-shaped core material 80, for example, made of a wooden material, adjacent to which the housing 5 of the flap fitting 4 is arranged, either over the entire width of the core material 80 or on an opening of the core material 80 which extends over only a part of the width of the core material 80. The housing 5 and the core material 80 are covered on the outer side by an outer layer 81 and on the inner side via an inner layer 82, wherein outer layer 81 and inner layer 82 can optionally also be embodied as structurally equivalent, for example, from a film or a decorative layer. In the illustrated exemplary embodiment, the inner layer 82 is fixed via fastening points on the core material 80 and the housing 5. The housing 5 can be adhesively bonded to the core material 5 or connected via fastening means. Due to the arrangement of the housing in the side wall of a furniture body, the housing is only visible from an end face with open flap 3 when the supporting lever 6 and the control lever 7 protrude forward.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 item of furniture
2 furniture body
3 flap
4 flap fitting
5 housing
6 supporting lever
7 control lever
8 rod
9 attachment
10 gear wheel
11 gear wheel
12 axis of rotation
13 gear wheel
14 axis of rotation
15 control disk
16 curve guide
17 guide element
18 holder
19 receptacle
20 force accumulator
21 spring
22 spring holder
23 rod
24 spring holder
25 fastening
30 damper
31 fastening element
32 contact surface
33 actuating element
50 side wall
51 side wall
52 spacer
60 axis of rotation
61 axis of rotation
70 axis of rotation
71 axis of rotation
72 actuating element
73 actuating roller
80 core material
81 outer layer
82 inner layer
83 fastening points
90 guide
91 pin
92 damper housing
93 piston rod
94 holder
96 damper

1-16. (canceled)

17. A flap fitting configured to attachment to a body and a flap of an item of furniture, wherein the flap fitting comprises:
a main body;
a supporting lever is indirectly or directly rotatably mounted on the main body;
a control lever pivotably mounted on the main body;
an attachment configured for attachment to the flap, wherein the supporting lever and the control lever are configured to be articulated with the flap on the attachment via spaced-apart axes of rotation; and
a damper arranged on the attachment, wherein the damper is a linear damper having a damper housing and a piston rod held displaceably on the damper housing, wherein the damper is actuatable via a movement of the supporting lever or the control lever during an opening movement of the flap before reaching a maximally open position of the flap,
wherein the attachment comprises an adjustment for adjusting the flap.

18. The flap fitting of claim 17, wherein the damper is pre-tensioned by a spring in an extended position.

19. The flap fitting of claim 17, wherein the attachment includes a guide and wherein the damper is retractable or extendable along the guide.

20. The flap fitting of claim 19, wherein the guide comprises an oblong hole or a groove in the attachment, wherein a guide element is guided in the oblong hole or groove in the attachment.

21. The flap fitting of claim 17, wherein the attachment comprises a U-shaped steel plate that accommodates the damper.

22. The flap fitting of claim 17, further comprising:
a force accumulator configured to pre-tension the flap in a closed position in a closing direction and configured to pre-tension the flap in an opening range in an opening direction.

23. The flap fitting of claim 17, wherein the damper indirectly or directly actuatable on the attachment via the movement of the supporting lever or the control lever during a closing movement of the flap before reaching a maximally closed position.

24. The flap fitting of claim 17, wherein an actuating surface is arranged on the supporting lever or on the control lever, wherein the actuating surface presses against an actuating surface of the damper from a predetermined angle position of the flap fitting.

25. The flap fitting of claim 24, wherein the damper comprises two actuating surfaces.

26. The flap fitting of claim 25, wherein the two actuating surface of the damper include a first actuating surface and a second actuating surface, wherein the damper is actuated by a first actuating surface during a closing movement and is actuated by a second actuating surface during an opening movement.

27. The flap fitting of claim 17, wherein the damper is aligned in parallel to a rear side of the flap in its longitudinal extension/axis of the piston.

28. The flap fitting of claim 17, wherein the position of the damper is adjustable to set the action range of the damper.

29. The flap fitting of claim 17, wherein a position of at least one actuating surface on the supporting lever or on the control lever is adjustable to set an action range of the damper.

30. An item of furniture, comprising:
a furniture body;
a flap; and
at least two flap fittings coupling the flap to the furniture body, each of the at least two flap fittings comprising
a main body;
a supporting lever is indirectly or directly rotatably mounted on the main body;
a control lever pivotably mounted on the main body;
an attachment attached to the flap, wherein the supporting lever and the control lever are configured to be articulated with the flap on the attachment via spaced-apart axes of rotation; and
a damper arranged on the attachment, wherein the damper is a linear damper having a damper housing and a piston rod held displaceably on the damper housing, wherein the damper is actuatable via a movement of the supporting lever or the control lever during an opening movement of the flap before reaching a maximally open position of the flap,
wherein the attachment comprises an adjustment for adjusting the flap.
